(19) United States
(12) Patent Application Publication
(10) Pub. No.: US 2023/0394540 A1
(43) Pub. Date: Dec. 7, 2023

(54) CAR SALES DEVICE AND ASSOCIATED METHODS

(71) Applicant: Mia Grace, Glen Allen, VA (US)

(72) Inventor: Mia Grace, Glen Allen, VA (US)

(21) Appl. No.: 18/127,988

(22) Filed: Mar. 29, 2023

Related U.S. Application Data
(60) Provisional application No. 63/324,836, filed on Mar. 29, 2022.

(51) Int. Cl. G06Q 30/06; G07C 5/00; G07C 5/08

(52) U.S. Cl. CPC G06Q 30/06; G07C 5/008; G07C 5/0816

(57) ABSTRACT

A car sales device for facilitating the car acquisition, inventory, reconditioning, maintenance, test driving, and sales processes. The car sales device may have at least one of console body, a car sales device computer system, an information display, a communication connector, key receptacle, and at least one indicator. The connector allows the transmission of information from a car's onboard computer system to the car sales device, where it may be displayed via the information display and indicator, allowing the device to indicate the status or progression of a car through the car buying process. The car sales device computer system may communicate with a car dealership's computer system, to aid in inventorying, maintenance, reconditioning, and various sales processes. Additionally, potential car buyers may use the car sales device to learn information about, and test drive, a car without unnecessary interaction with dealership staff.

### FIELD OF THE INVENTION

This invention relates to one or more car sales devices configured for facilitating the car acquisition, inventory, reconditioning, maintenance, test driving, and sales processes. The associated method relates to a method for using the device which enables sellers and potential car buyers to interact with, and be informed about, a car and the car buying process. An embodiment of the car sales device can be attached to a portion of car or, in another embodiment, may be a car buyer's and/or car seller's mobile device with car sales software installed, for example. In one embodiment, a least one of the car sales devices have a wired or wireless connection to the OBD-II system (or similar connected or wireless system), another information system or computer system of the car, or a dealership computer system. In embodiments with a connection to the OBD-II system this connection is configured to allow the transfer of information between the car's onboard computer system, the car sales device, or a mobile device such as, but not limited to, a tablet or a smart phone.

In one embodiment, the device is able to be wirelessly connected to a seller's inventory systems or other related monitoring systems (like, a car dealership computer system), to communicate the car information and/or the car's status in inventory to the related monitoring system. The car sales device may further comprise an information display, which allows a potential buyer, maintenance worker, and/or a seller to interact with the car sales device, as well as learn information about a car's history and status. Additionally, the car sales device may communicate with an external computer, smart phone, tablet, or other electronic device.

Embodiments of the car sales device may comprise components, and methods for using the same, that assist in and make the used car reconditioning process more efficient. An embodiment of the car sales device comprises at least one indicator which may be an indicator light or indication on the information display of the car sales device, the monitoring system, or a app on a mobile device. The indicator is configured to indicate the status of the car, its progression through various dealership processes, such as reconditioning, repairing, refueling, cleaning, or other similar reconditioning process performed on a car, its availability for a test drive or sale, for example.

An embodiment of the car sales device is connected to a car in the inventory of the car dealership and comprises the key for the car in a lockable key receptacle in the car sales device. In such embodiments, the car sales device that may be unlocked with a key, an password code, or an electronic device such as a smart phone or fob. In some embodiments, a plurality of car sales devices are individually associated with a plurality of cars in inventory of a car dealership and the same key, code, or electronic device may unlock more than one car devices to allow a person such as a sales person, a potential car buyer, or a maintenance person with access to multiple cars.

### BACKGROUND OF THE INVENTION

Innovation in the field of car sales is much needed, as many car sellers (“dealers”) have used the same processes, and seldom-evolving technology, to operate their dealerships (“car lots”) for over a decade. Dealerships are traditionally teaming with energetic and pushy salespeople who engage the consumers who dare venture onto car lots. The experience of buying a car from a salesperson is often unnerving for potential car buyers, especially if those potential buyers are “just looking.” An energetic salesperson's desire to make a quick sale is often at odds with a buyer's desire to learn about their options and make an informed consumer choice.

On one side of the car buying equation, a trip to the local car dealership, usually involves a potential buyer travelling to the new or used lot and looking around the inventory. The next step involves a meeting and greeting by the salesperson, and a conversation ensues. Potential buyers often have many questions about the inventory, ranging from drivetrain and gas mileages to safety standards, and other standard and optional features. While some dealerships have stickers or displays near or on the vehicles, many of their questions still require answers from a salesperson, which then may require one or more trips inside the dealership building/office. Once those questions have been successfully fielded by the salesperson, the next step in the process is usually a test drive. In conventional car dealerships, a salesperson must be present to interact with the customer to arrange for a test drive. The salesperson must go inside the office, make copies of the potential buyer's identification, and retrieve the correct keys for the vehicle. If a potential buyer wants to test drive more than one car, what was once foreseen as a quick trip to the local dealership can easily turn into a prolonged, inconvenient experience. The sales process can be just as frustrating for the salesman as many people just go looking and may just waste the salesperson's time.

On the other side of the car buying equation, the car acquisition process for a dealership is a multi-step process, requiring processing the car into inventory and getting it into the proper condition for a test drive or sale. All cars available for a test drive and sale must be fueled, cleaned, and in good working condition before they can be driven by a potential buyer. Reconditioning, servicing, and providing any essential repairs or maintenance are especially important in the case of used cars being offered for sale. The service center of a dealership can only process so many cars at a time, and as cars are continuously being taken out for test drives, keeping track of which cars need further work or refueling can be difficult and time consuming, even for the most organized dealerships.

There remains a need in the art for a device and an associated method which streamline the inventory and acquisition processes, and which improve the test driving, car buying and selling experiences, making them more efficient and enjoyable for both parties. The present invention, the car sales device and associated method fills that need.

### BRIEF SUMMARY OF THE INVENTION

In an embodiment, the car sales device comprises a connector, console body, and an information display. The connector is configured to be reversibly attachable to a car to connect the car sales device to a car in the inventory of a car dealership. The information display is connected to the console body and configured to display or otherwise convey information regarding the car's history or other information, a mechanical report on the car, itemization of the car price, specifications, and status in the selling process to both the buyer and seller of the car. The information display is connected to the console body and is configured to display information to the user of the car sales device regarding the car's status in inventory, as well as information concerning a possible test drive and/or sale of the car.

The connector is configured to be reversibly attachable to a car. The car sales device may be configured to allow the transmission of data between a car's onboard computer system and computer system in the car sales device for display on the car sales device.

In additional embodiments, the car sales device comprises addition components. In one embodiment, the car sales device also comprises a key receptacle, the key receptacle being connected to the console body. The key receptacle may contain the key to the car and be opened to make the key available by properly requesting a test drive or for maintenance, for example. In such embodiments, the car sales device that may be unlocked with a key, a password code, or wirelessly with an electronic device such as a smart phone or fob through WIFI or blue tooth, for example.

In some embodiments, the car dealership has a plurality of cars with car sales devices individually associated or connected the plurality of cars. A customer may be given a key, pass code, or an app that allows access and to unlock the key receptacles of more than one car in the inventory of the car dealership. The customer may then access the key of any of the available cars through the individually associated car sales devices. The customer may unlock any of the available cars and may test drive them merely by unlocking the key receptacle with their assigned key, code, or electronic device. In some embodiments, the car sales device may be remotely programed with the pass code or to accept wireless commands to unlock the key receptacle from a mobile device. The pass code may be entered through a series of buttons or a touch screen, for example.

The key receptacles may be available only to certain classes of person. The car sales device may be available to potential buyers, salespersons, maintenance personnel. If the car is not ready for customer viewing or test driving, a key, pass code, or wireless “key” provided to a potential buyer or customer will not open the key receptacle. The potential buyer or customer will have access to unlock all the car sales devices associated with cars available for purchase or test drive. In yet another embodiment, the key receptacle may be locked and unlocked remotely.

In another embodiment, the car sales device does not comprise an information display, but does comprise at least one indicator which is configured to convey information concerning a car to a seller and a potential buyer.

In another embodiment, the car sales device also comprises at least one scanning unit, the scanning unit being connected to the console body. The scanning unit may scan at least one of a potential buyer's identification (such as a driver's license), their face for facial recognition, and/or a method of payment such as a credit card. The scanning unit may be a bar code reader, a QR code, a camera, or other optical imaging reader.

In another embodiment, the car sales device may comprise at least one set of at least two indicator lights. The indicator lights may be of different colors and may convey inventory information to the buyer or seller. The inventory information may comprise the status of the car in the inventory system, the stage of processing of intake of the car, the test drive status of the car, or other information, for example. As stated above, other embodiments of the car sales device comprise indicators that are displayed on a screen rather than external lights.

In another embodiment, the car sales device also comprises a global positioning system (GPS) tracker or GPS locator, which allows a dealership's system to monitor the location of a car. The GPS locator may monitor the location of the car at location within the dealership, a third-party service center, or on a test drive, for example. Internal technicians, external vendors, and sales departments, who utilize the systems and devices in the prior art, commonly complain about how difficult it is to locate vehicles in a timely manner, especially if they are attempting to locate one specific car amongst a sea of similar vehicles. When there are over a hundred cars, and several different lots, these professionals may expend a significant amount of time locating their desired vehicle; being able to pinpoint the vehicle with GPS locator will greatly assist in accomplishing that task. Alternatively, the car sales device may communicate with a GPS device that is part of the car's onboard computer system, for example. This location of the car may be communicated from the car's onboard computer system to the car sales device.

In yet another embodiment, the car sales device is configured maintain a wireless connection with a car dealership's computer system. In additional embodiments, the car sales device also comprises at least one camera, microphone, speaker, motion sensor, accelerometer, or biometric scanner.

Other embodiments of the present invention alter and specify previously listed components of the car sales device. In one embodiment, the console body consists of a rectangular prism or hyperrectangle. In one embodiment, the information display is a touchscreen display; while in another embodiment, the information display is a weatherproof touchscreen LED display. In another embodiment, the communication connector is a cable configured for the reversible connection of the car sales device to a car's onboard computer system, also known as the car's diagnostics system. In the art, the diagnostics system of a car may store, gather, and transmit information about the car, its operations, and the status of various car systems. Prior art diagnostics systems can typically be accessed via a diagnostics port. An example of a car diagnostics system is an On-Board Diagnostics II (or “OBD-II”) system; this system is a common amongst modern cars and other vehicles. A car's OBD-II system may be accessed via the car's OBD-II port. In another embodiment of the invention, the communication connector is a cable configured for the reversible connection of the car sales device to a car's OBD-II port. In another embodiment, the communication connector establishes a wireless connection with car's onboard computer system. A wireless connection may include a wireless transmitter and/or receiver plugged into the car's communication port.

An embodiment of the present invention also comprises the processes by which both a potential car buyer and a car seller may use a car sales device to facilitate the purchase and sale (respectively) of a car.

### BRIEF DESCRIPTION OF THE FIGURES

FIG. 1 shows a partial view of an embodiment of the present invention, showing a frontal view of a car sales device.

FIG. 2 shows a diagram of the process by which a potential car buyer may use the car sales device to facilitate the purchase of a car.

FIG. 3 shows a diagram of the process by which a seller may use the car sales device to facilitate the sale of a car.

### DETAILED DESCRIPTION

A car dealership, typically, will have a plurality of cars in inventory including new and used cars. The car dealership may have processes that that may be followed from when a car is initially delivered to the dealership until the car is available for test driving or sales to a customer. A newly received car may not be available for viewing or test driving until the maintenance personnel have cleaned, determined the condition of the car, conducted required maintenance, and refueled. The car may also need to be properly added into the inventory of the car dealership computer system that lists the inventory of the dealership. A car sales device may assist in the intake and inventory management, monitoring of the cars in inventory, and indicate the status of the car in the process (newly received, requires maintenance, or available for test driving and sales, for example.)

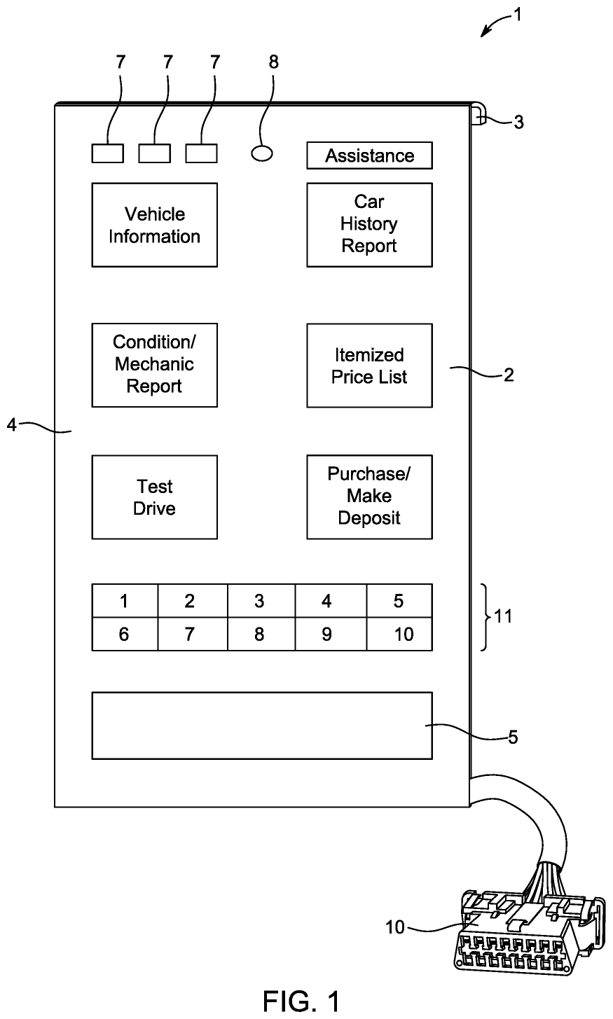

Referring now in detail to the drawing figures, wherein like reference numerals represent like parts throughout the several views, FIG. 1 illustrates a view of an embodiment of the car sales device, the car sales device 1 comprising a console body 2, an information display 4, a key receptacle 5, three indicators 7, a scanning device 8, and a communication connector 10. The communication connector 10, scanning unit 8, indicators 7, key receptacle 5, and information display 4 are connected to the console body 2. The console body may comprise physical input keys or a virtual keyboard 11 for input of a pass code or other information. In this embodiment of the car sales device, the console body 2 comprises the shape of rectangular prism or hyperrectangle. In additional embodiments of the invention, the console body 2 comprises the shape of another (or different) three-dimensional shape(s). The car sales device may comprise a connector 3 to connect the car sales device 1 to a car. In the shown embodiment, the car sales device 1 comprises a connector 3 that may be hooked over a window of the car and the window raised to connect the car sales device 1 to a car. In additional embodiments of the car sales device, the console body 2 defines one or more locking mechanism which are configured allow the console body 2 to be connected to one or more of the other components of the car sales device. For example, the console body 2 is configured to be reversibly attachable to the side mirror portion of a car. In additional embodiments of the present invention, the console body 2 may be reversibly connected to a different portion of a car.

The console body 2 of the car sales device may be made from any suitable material. For a material to fit this description of “any suitable material” it must I some embodiments wherein the car sales device is connected to the exterior of the car (at least partially) be able to safely to house electrical components and be weather resistant or weatherproofed for outdoor use. Examples of suitable materials from which the console body may be made include, but are not limited to, plastic, steel, rubber, composite materials, polymeric materials, corrosion resistant material, aluminum, or some combination thereof.

In an embodiment of the present invention, the information display 4 is connected to one face of the hyperrectangular shaped console body 2, the information display 4 may be weather and nature resistant. The information display 4 may be made from any suitable materials, although in an embodiment shown in FIG. 1, the information display 4 consists of a weatherproof touchscreen LED display. The weatherproofing of LED displays, and other types of displays, is well known in the art. The information display 4 is able to relay various types of information, like information regarding the history of the car, a condition/mechanic report, itemized price breakdown, and the status of the car in inventory, for example. The information may include, but is not limited to, the car's make, model, year, drivetrain, transmission, gas mileage, crash history, maintenance record, all other information available through the OBD-II system and OBD-II port, date of cleaning, price for sale, and financing details. The information relayed by the information display 4 may be supported by software and various hardware components, as needed. In one embodiment, the car sales device is able wirelessly transmit and receive information from the seller's (dealership's) own internal systems and, in some embodiments, the car's onboard computer system. Internal systems used by dealers are often operated from within the dealership building/office, but these systems (for example, car inventory systems) can often be accessed on off-site devices, through the internet, the cloud, servers, and/or the dealership's website. An embodiment of the invention may also comprise a locator, such as a GPS locator, either in communication with the car sales device computer system or integrated into the car sales device computer system. The GPS locator is able to be monitored via the car dealership computer system, for example. Additional embodiments of the invention comprise locators which utilize another technology, such as near field communication, Wi-Fi, or a cellular signal, for its location functionality.

In another embodiment, the car sales device is configured to engage with a seller/dealership's computer system (through software or hardware) to allow potential car buyers to input financial information, upload identification, arrange for financing, and sign contracts via interaction with the car sales device or the information display 4 of the car sales device. Additional embodiments of the car sales device are configured to allow the input of buyer information into the seller/dealership's internal system prior the potential buyer first in-person interaction with the car sales device; this configuration of the car sales device allows the car sales device to quickly access the buyer's information, or be preloaded with that information, for the buyer's in-person interaction with the car sales device.

The information display 4 allows a potential buyer of a car to easily learn details about the car, without the need for excessive contact with the seller or dealership staff. Now looking to the embodiment of the invention shown in FIG. 1, the information display 4 being a touchscreen display also allows dealership staff and potential car buyers to input information into the dealership's system directly from the display. For example, a potential car buyer may be able to input identification information into the inventory system using the touchscreen (via a virtual keyboard) on the information display 4, which grants the potential buyer access to the key receptacle 5 to test drive the vehicle. The car sales device does not allow unlocking of the key receptacle by a potential buyer, unless the car status indicates that the car is ready for a test drive and the time is within the hours of operation of the dealership. Additionally, the car may not b available for test drive if it doesn't have sufficient fuel levels and be sufficiently maintained or repaired to allow the test drive.

In another example, a potential buyer may also utilize the touchscreen (via virtual buttons) on the information display 4 to scroll through/see more information about the vehicle, to report an issue with the vehicle, enter pass codes to unlock the key receptacle, and/or to request assistance from dealership staff. The dealership staff may similarly use to the touchscreen on the information display 4 to change the functions, input information, or change the status of the indicators 7 such as test drive status, operate the key receptable 5, use scanning unit 8, and operate the communication connector 10 to upload information from the cars onboard computer to the car sales device.

An embodiment of the present invention comprises three indicators 7 which may be lights or indications on the screen 7, the indicators 7 being connected to the console body 2. In another embodiment, the indicators 7 are connected to the upper face of hyperrectangle shaped console body 2. The indicators 7 may be made from any suitable material and may also be weatherproofed. In an embodiment of the invention, the three indicators 7 are differentiated by color, with one light being green, another being yellow, and another being red, for example. The differentiation in color on the indicators 7 allows the dealership staff and potential car buyers to more easily find cars which are ready to be test-driven, need maintenance or fuel, or are ready to be sold. For example, when the green indicator light 7 is illuminated, it may denote that the car has been processed, required maintenance has been performed, the car has been cleaned, the fuel tank is sufficiently filled, and the car is ready to be test driven and sold. The indicators 7 may also serve the purpose of notifying the dealership staff of cars which still require processing, maintenance, or cleaning. The indicators 7 being attached in a prominent position on the console body 2 allows the dealership staff to easily identify and evaluate car inventory. The indicators 7 also allow quick evaluation of car inventory without having to look more closely at the information display 4 or other dealership systems. In additional embodiments, the status is indicated on the information display 4 of the car sales device, on the dealership's computer systems, or both.

An embodiment of the present invention comprises a key receptacle 5, the key receptable 5 being connected to the console body 2. The key receptacle 5 may be made from any suitable material and may be weatherproofed to protect the key. As used herein, the term “key” is not rigid in its definition, but refers to a traditional metal car key, a car clicker, remote, fob, or other forms of car key which allows the interior of the car to be accessed and/or the allows for the operation of the car (whether human operated or computer operated). In additional embodiments, the key receptacle 5 works similar to a lockbox for a for-sale home. The key receptacle 5 is able to securely hold a key to a car, and the key receptacle 5 may be locked and unlocked. When the key receptacle 5 is unlocked, dealership staff or potential car buyers may insert a key into the key receptacle 5, enter a pass code, or remove a key from the key receptable 5. In an embodiment, the key receptacle 5 may be locked or unlocked remotely; additional embodiments of the key receptacle 5 allow it to be locked and unlocked mechanically or through the use of a key or code. In an embodiment of the present invention, the key receptacle 5 is able to be remotely unlocked using the dealership's systems as well as through inputs on the information display 4. The customer may request an appointment and sign in online to obtain a passcode or may obtain a passcode from a salesperson. In this way, a customer may have access to all the available cars in inventory without the assistance of a salesperson. The customer may choose any available car, enter their individual passcode, and access the interior of the car or test the drive car at their convenience.

Upon returning car to the dealership (determined from GPS information, wifi, or other proximity system, for example) the car sales device may request feedback of their test drive experience and ask whether they would like to place a deposit or purchase the car.

In an embodiment of the car sales device, the scanning unit 8 is able to scan barcodes and QR codes, specifically those found on government identification cards/documents/records. The scanning unit 8 is connected to the console body 2. In one embodiment of the invention, the scanning unit 8 is connected to the bottom face of the hyperrectangle shaped console body 2. For a potential car buyer, the scanning unit 8 offers a seamless option for recording and verifying identification for the purpose of test driving and purchasing a vehicle. The devices and methods of the prior art necessitate that the dealership make a copy of the potential buyer's driver's license in the dealership office before a car can be test driven. By contrast, the scanning unit 8 on the console body 2 is able to record and verify the potential buyer's identity without the need for excessive interaction with the dealership staff. Information gathered from the scanning unit 8 is able to be sent to the dealership's systems for monitoring and record-keeping without in-person interaction between the potential buyer and the dealership staff.

An embodiment of the present invention comprises a communication connector The connector is a component which is able to transmit information from the car's internal systems to the car sales device. In this embodiment, the communication connector 10 is a cable which connects the OBD-II port in a car to the car sales device. Information that can be gathered from the OBD-II port, such as diagnostics, service reminders, and fuel level are transmitted through the communication connector 10 to the car sales device systems. The information transmitted by the communication connector 10 allows the information display 4 and indicators 7 to give real time information about the car's status to both potential car buyers and sellers (dealership staff). The information transmitted by the communication connector 10 can also be monitored remotely, as the car sales device is able to maintain wireless connection between itself and the dealership's systems to transmit and relay information about the car.

Additional embodiments of the present invention are numerous and should not be interpreted as being limited by those described fully herein. In additional embodiments of the present invention, the car sales device consists of a different number of indicators 7. For example, in one embodiment of the present invention, the car sales device consists of only one indicator 7 which indicates whether the car is ready to be test driven.

In additional embodiments of the present invention, there is no key receptacle 5, or the key receptacle 5 takes on a different form and purpose. For example, in another embodiment of the present invention, the key receptacle 5 does is not similar to a lockbox and it does not store a physical car key, but rather the key receptacle 5 is an electrical or software component of the car sales device which allows the access to the interior of the car and allows for the operation of the car without the use of a traditional car key/fob. In this embodiment, the key receptacle 5 is able to grant interior and operational access to the car to dealership staff and potential car buyers through the communication connector 10. For example, the car may be remotely accessed without a physical key through electronic communication with the car. In yet another embodiment of the present invention, the car sales device does not comprise a GPS locator, but rather the car already comprises locator technology, and that information is relayed through the communication connector 10.

In another embodiment of the invention, the car sales device comprises a console body, a car sales device computer system, a connector, an information display, and at least one indicator. The console body is reversibly attachable to a car. The car sales device computer system is configured to be able to communicate with an onboard computer system in the car to access information stored in the onboard computer system in the car. The car sales device is configured to be able to communicate with a car dealership computer system to provide the information to the car dealership computer system. The car sales device computer system is connected to the console body or housed within the console body. The connector is configured to allow the communication of information between the car sales device and an onboard computer system in the car. The connector is connected to the car sales device computer system. The information display is in communication with the car sales device computer system and is configured to relay information from the car sales device computer system to a user of the car sales device. The indicator is able to relay information regarding the status of the car, and the indicator is a portion of the information display, a separate display, or an indicator light. In additional embodiments of the invention, the status of the car (a “car status” or a “status”) relayed via the indicator and/or the information display refers to the at least one of maintenance status, fuel status, test drive readiness status, and sales readiness status.

In another embodiment, the car sales device comprises and input device for imputing information into the car sales device computer system. The input device may input information via wireless technology or through some wired means. In some embodiments, the input device comprises a keyboard, a touchscreen, or both.

Other embodiments of the car sales device include components for safety, as well as additional components to ensure a secure and easy car selling and buying process. These components include, but are not limited to, cameras, microphones, speakers, motion sensors, accelerometers, and biometric scanners.

In additional embodiments, the information display, the indicator, or both may be able to relay any information used by, stored in, transmitted to, or analyzed by the car sales device computer system (and/or some other component of the car sales device, including, but not limited to, the scanning unit and input device, for example) to a user of the car sales device. In an embodiment of the car sales device, the information used by, stored in, transmitted to, or analyzed by the car sales device computer system comprises at least two of the following: a car's make, model, year, drivetrain, transmission, gas mileage, crash history, maintenance record, information available via the onboard computer system of the car (including, information available through the OBD-II system and OBD-II port), car status (such as, but not limited to, maintenance status, fuel status, test drive readiness status, and sales readiness status, for example), date of cleaning, price for sale, and financing details. The information which may be stored in the onboard computer system in a car includes a large variety of information, such as, but not limited to, engine computer data, sensor inputs, computer outputs, interpreted data involving learned variables, trouble codes, stored codes, recorded operational conditions at the moment the code set, transmission control module data, transfer case control module data, antilock brake control module data, body control module data, door control module data, pressure monitor data, remote function actuator module data, HVAC control module data, steering control module data, collision avoidance module data, air bad control module data, mileage, car make, car model, car VIN number, car serial number, car production data, event critical vehicle operating data, vehicle speed (past and current) data, brake input data, seatbelt buckle status data, data on past and current driving habits, for example. In another embodiment of the car sales device, the information used, stored, transmitted to, or analyzed by the car sales device computer system comprises at least three of the following: a car's make, model, year, drivetrain, transmission, gas mileage, crash history, maintenance record, information available via the onboard computer system of the car (including, information available through the OBD-II system and OBD-II port), date of cleaning, price for sale, and financing details. In yet another embodiment of the car sales device, the information used, stored, transmitted to, or analyzed by the car sales device computer system comprises at least five of the following: a car's make, model, year, drivetrain, transmission, gas mileage, crash history, maintenance record, information available via the onboard computer system of the car (including, information available through the OBD-II system and OBD-II port), car status (such as, but not limited to, maintenance status, fuel status, test drive readiness status, and sales readiness status, for example), date of cleaning, price for sale, and financing details. In yet another embodiment of the car sales device, the information used, stored, transmitted to, or analyzed by the car sales device computer system comprises at least nine of the following: a car's make, model, year, drivetrain, transmission, gas mileage, crash history, maintenance record, information available via the onboard computer system of the car (including, information available through the OBD-II system and OBD-II port), car status (such as, but not limited to, maintenance status, fuel status, test drive readiness status, and sales readiness status, for example), date of cleaning, price for sale, and financing details.

In another embodiment of the invention, a method of use for a car sales device by a seller, comprises the following. The seller acquires both a car and car sales device. The car sales device comprises a console body, a car sales device computer system, a connector, an information display, and at least one indicator. The console body is reversibly attachable to a car. The car sales device computer system configured to be able to communicate with an onboard computer system in the car to access information stored in the onboard computer system in the car. The car sales device is configured to be able to communicate with a car dealership computer system to provide the information to the car dealership computer system. The car sales device computer system is connected to the console body or housed within the console body. The connector is configured to allow the communication of information between the car sales device and an onboard computer system in the car. The connector is connected to the car sales device computer system. The information display is in communication with the car sales device computer system and is configured to relay information from the car sales device computer system to a user of the car sales device. The indicator is able to relay information regarding the status of the car, and the indicator is a portion of the information display, a separate display, or an indicator light. The input device is able input information into the car sales device computer system. associating the car sales device to the car in the car dealership computer system. The status of the car is determined using the information stored in the onboard computer system in the car, using information communicated from the car dealership computer system, or using information input into the car sales device computer system from the input device, wherein the status of the car comprises at least one of maintenance status, fuel status, test drive readiness status, and sales readiness status. The status of the car is communicated to the dealership computer system, and the status of the car is indicated on the car sales device.

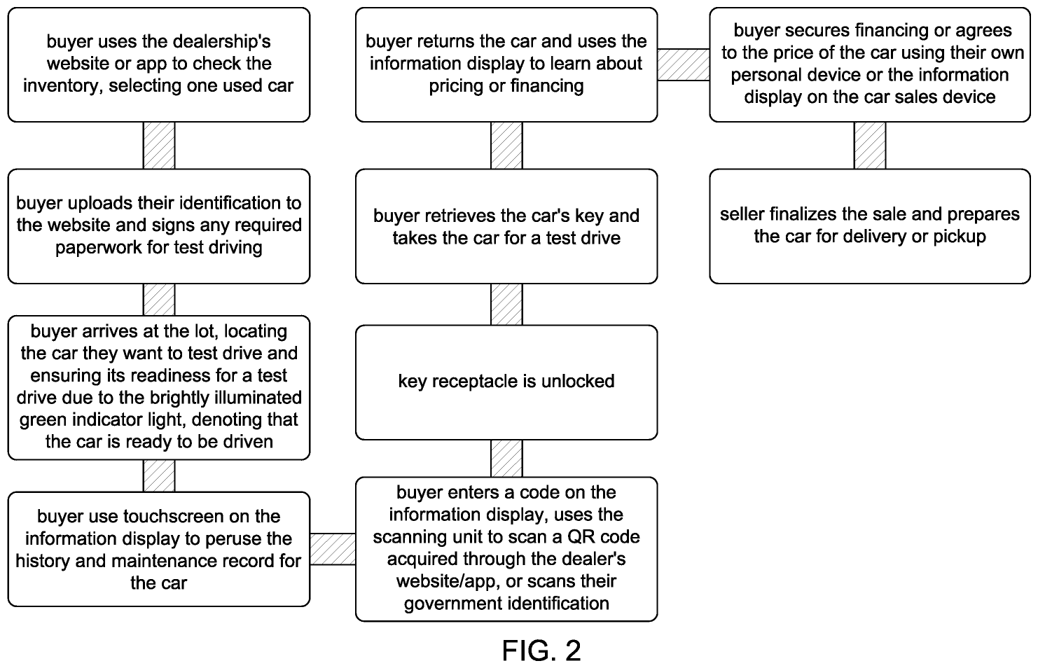

Now looking to FIG. 2, an embodiment of the present invention is shown as diagram of the method by which a potential car buyer may use the car sales device to facilitate the purchase of a car. A potential car buyer may use the dealership's website or app to check the inventory: finding a few cars within their price range and preferred specifications and narrowing their selections down to one car. The car sales device is configured for use on many types of cars and car transactions, including, but not limited to the sale of new or used cars, car leasing, and carrental, for example. The potential buyer may upload their identification to the website (even through a mobile device) and sign any required paperwork for test driving, all before ever venturing to the lot. Then, when that potential buyer arrives at the lot, they are able to locate the car they want to test drive. Finding the car and ensuring its readiness for a test drive will only be made easier due to the indicator, denoting that the car is ready to be driven. In additional embodiments, the indicator comprises a green indicator light, which may become illuminated to relay to users of the car sales device that the car is ready to be test driven.

Before driving away, the potential buyer may need to refresh their knowledge about the car by using the touchscreen on the information display to peruse the history and maintenance record for the car. After being satisfied by learning more about the car, the potential buyer may then enter a code on the information display, use the scanning unit to scan a QR code acquired through the dealer's website/app, or scan their government identification, which in turn causes the key receptacle to unlock. The potential buyer can then retrieve the car's key and take the car for a test drive. Being satisfied with the test drive, the potential buyer can return the car to its spot in the lot and then use the information display to learn more about pricing or financing. The potential buyer can then secure financing or agree to the price of the car using their own personal device or the information display on the car sales device. Once the potential buyer is satisfied, the car seller can finalize the sale and prepare the car for delivery or pickup.

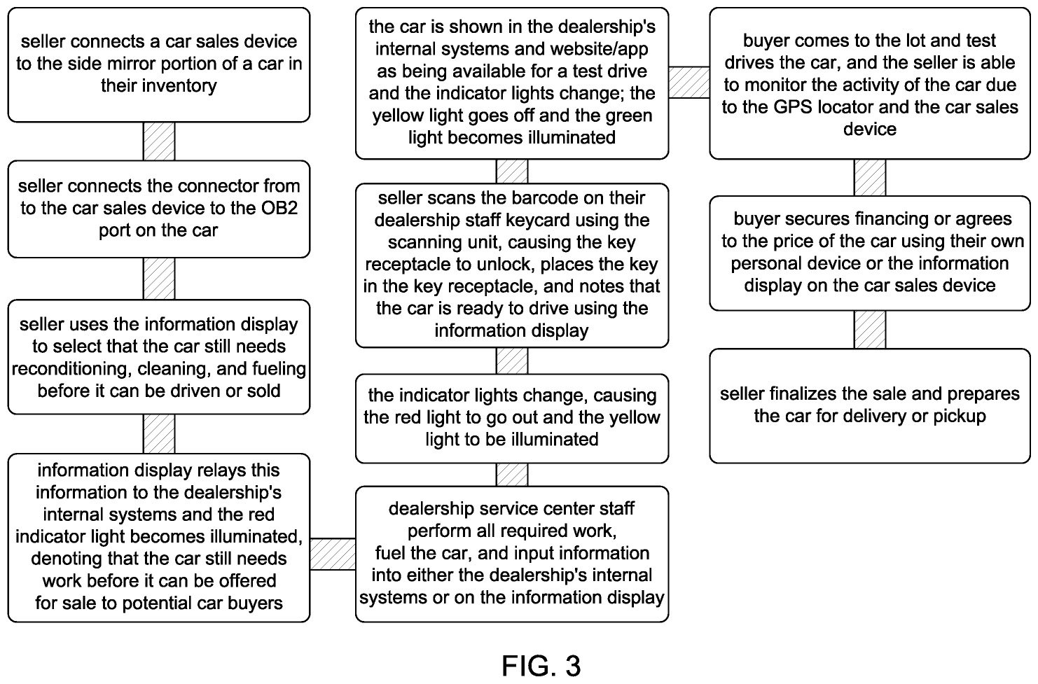

Now looking to FIG. 3, an embodiment of the present invention is shown as diagram of the method for use of the car sales device by a car seller to facilitate the sale of a car. The seller may first begin by connecting a car sales device to the side mirror portion of a car in their inventory and connecting the connector from to the car sales device to the OBD-II port on the car. Knowing that this used car was recently added to the inventory, the seller then uses the information display to select that the car still needs reconditioning, cleaning, and fueling before it can be driven or sold. The information display relays this information to the car dealership's computer system (where it is recorded) and the status indicator becomes illuminated, denoting that the car still needs to be put into good working condition before it can be offered for sale to potential car buyers. The dealership's service center performs all required work and fuels the car; they change the information in either the car dealership's computer system or on the information display or another part of the car sales device to reflect their work. The car sales device, being in communication with the car dealership computer system, causes the status change resulting from the completed service to be indicated via the indicator.

The seller then scans the barcode on their dealership staff keycard using the scanning unit, causing the key receptacle to unlock. The seller then places the key in the key receptacle and notes that the car is ready to drive using the information display. The car is shown in the dealership's internal systems and website/app as being available for a test drive. The indicator lights change, the yellow light goes off and the green light becomes illuminated. A potential car buyer comes to the lot to test drive the car; they are able to complete the process without assistance. The seller is able to monitor the activity of the car (including its location) due to the GPS locator and the car sales device. The potential buyer indicates their intent to buy the car in full. The seller finalizes the sale and prepares the car for delivery or pickup.

Embodiments of the car sales device may assist in keeping track of the reconditioning process (as defined by the dealership) for each car and coordinating and scheduling the different vendors that are performing steps involved in the reconditioning process. For example, third party vendors may be responsible for dent repair, paint repair, upholstery cleaning and/or repair, key replacement, headlight restoration, windshield repairs, key replacements, etc. When a third-party repair or service is determined to be needed, the car sales device or system would alert the third party vendors and then they can come and service the vehicle and have access to all the inventory without having to run around finding the specific cars and trying to figure out what needs to be done from dealership employees. Embodiments of the car sales device will assist third party vendors and employees assigned reconditioning tasks to find the particular vehicle needing service and inform them specifically what needs to get done to each car without having to bother other employees. In these embodiments, the car sales device increases efficiency, allowing for reconditioning with minimum communication, explanation, and/or authorization by specific employees. This innovation prevents or reduces incidents of vendors not being able to locate the specific vehicles requiring service and leaving without performing the required service.

Further embodiments of the car sales device may comprise indications that a car may need attention, service, and/or maintenance that occur after the car has been completely reconditioned and indicated to be ready for sale. The car sales device may comprise indicator lights or other communication modules the indicate to reconditioning staff, maintenance staff, or third party vendors that the car has an issue such as, but not limited to, a check engine light or any other indicator light comes on, the car computer indicates any issue the car may have experienced, the car needs refueled, or the battery needs to be charged, for example.

Numerous characteristics and advantages have been set forth in the foregoing description, together with details of structure and function. The present invention can be manufactured in varying sizes depending on the application. While the invention has been disclosed in its preferred forms, it will be apparent to those skilled in the art that many modifications, additions, and deletions, especially in matters of shape, size, and arrangement of parts, can be made therein without departing from the spirit and scope of the invention and its equivalents as set forth in the following claims. Likewise, while the associated processes have been disclosed in their preferred forms, it will be apparent to those skilled in the art that many modifications can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

1. A car sales device, comprising:
a console body, the console body being reversibly attachable to a car;
a car sales device computer system, wherein the car sales device computer system is in communication with an onboard computer system in the car to access information stored in the onboard computer system in the car, and wherein the car sales device computer system is configured I communication with a car dealership computer system, the car sales device computer system being connected to the console body or housed within the console body;
a communication connector, the communication connector providing the communication between the car sales device computer system and the onboard computer system;
an information display, the information display being in communication with the car sales device computer system; and
at least one indicator, the indicator indicating a status of the car, wherein the indicator is at least one of a portion of the information display, a separate display, or an indicator light.

2. The car sales device of claim 1, comprising an input device for inputting information into the car sales device computer system.

3. The car sales device of claim 2, wherein the input device comprises a keyboard, a touch screen, or both.

4. The car sales device of claim 1, wherein the information display comprises a touchscreen display.

5. The car sales device of claim 1, wherein the at least one indicator is at least one indicator light.

6. The car sales device of claim 1, wherein the connector consists of a cable connecting a car's OBD-II port to the car sales device.

7. The car sales device of claim 1, comprising a GPS locator either in communication with the car sales device computer system or integrated into the car sales device computer system, the GPS locator being able to be monitored via the car dealership computer system.

8. The car sales device of claim 1, comprising a scanning unit connected to the console body, the scanning unit being in communication with the car sales device computer system.

9. The car sales device of claim 1, comprising a lockable key receptacle connected to the console body.

10. The car sales device of claim 1, comprising at least one of a camera, microphone, speaker, motion sensor, accelerometer, or biometric scanner.

11. A car sales device, comprising:
a console body, the console body being reversibly attachable to a car;
a key receptacle, the key receptacle connected to the console body;
a car sales device computer system, wherein the car sales device computer system is in communication with an onboard computer system in the car to access information stored in the onboard computer system in the car, the car sales device computer system being connected to the console body or housed within the console body;
a communication connector, the communication connector being configured to allow the communication of information between the car sales device and an onboard computer system in the car, the communication connector being connected to the car sales device computer system;
an information display, the information display being in communication with the car sales device computer system, the information display being configured to relay information from the car sales device computer system to a user of the car sales device; and
at least one indicator, the indicator being able to relay information regarding the status of the car to the user of the car sales device, wherein the indicator is at least one of a portion of the information display, a separate display, or an indicator light.

12. The car sales device of claim 11, wherein the key receptacle may be locked and unlocked remotely.

13. The car sales device of claim 11, comprising an input device for inputting information into the car sales device computer system.

14. The car sales device of claim 11, and wherein the car sales device computer system is in communication with a car dealership computer system to provide the information to the car dealership computer system and accept information from the car dealership computer system.

15. The car sales device of claim 11, comprising a GPS locator either in communication with the car sales device computer system or integrated into the car sales device computer system, the GPS locator being able to be monitored via the car dealership computer system.

16. The car sales device of claim 11, comprising a scanning unit connected to the console body, the scanning unit being in communication with the car sales device computer system.

17. The car sales device of claim 11, comprising at least one of a camera, microphone, speaker, motion sensor, accelerometer, or biometric scanner.

18. (canceled)

19. A system for using multiple car sales devices, comprising:
a plurality of car sales devices reversibly attached to a plurality of cars in an inventory of a car dealership;
wherein each of the car sales devices comprises:
a connector reversibly connecting the car sales device to one of the cars in the inventory of the car dealership;
a lockable key receptacle, wherein the key receptacle contains a key for the car;
a car sales device computer system wherein the car sales device unlocks the lockable key receptacle upon entry of a pass code; and
a dealership computer system in communication with car sales devices to communicate the pass code at least a portion of the plurality of car sales devices to grant a potential car buyer access to the portion of the keys in the key receptacles of the portion of car sales devices, thereby the potential car buyer is able to test drive all of the cars for which it has access to the key receptacle of the car sales device.

20. The system of claim 19, wherein the car sales device computer system is in communication with an onboard computer system in the car to access information stored in the onboard computer system.
